(19) United States
(12) Patent Application Publication
(10) Pub. No.: US 2017/0353798 A1
(43) Pub. Date: Dec. 7, 2017

(54) HEADBAND FOR HEADPHONE

(71) Applicant: GIBSON BRANDS, INC., Nashville, TN (US)

(72) Inventors: Rojkarnjanarak GARAN, Kowloon (HK); Liu Wai HUNG, Ma On Shan (HK); Chuk Ki CHAN, Kowloon (HK)

(21) Appl. No.: 15/539,679

(22) PCT Filed: Dec. 24, 2014
(86) PCT No.: PCT/EP2014/079291

§ 371 Date: Jun. 24, 2017

(51) Int. Cl. H04R 5/033; H04R 1/10

(52) U.S. Cl. CPC H04R 5/0335; H04R 1/105; H04R 1/1066

(57) ABSTRACT

A headband for a headphone, the headband comprising: a primary band for placement over a user's head to support the headphone on the user's head; and a secondary band mounted to the primary band, the secondary band rotatable relative to the primary band into one or more indexed positions to further support the headphone on the user's head.

### FIELD OF THE INVENTION

The invention relates to headbands, and has been described herein primarily in relation to use in headphones, but is not limited to this particular application.

### BACKGROUND OF THE INVENTION

Headphones typically comprise a headband that fits over the head of a user. At one or both ends of the headband are mounted earspeakers. The earspeakers can be of various types, including supra-aural earspeakers (on-ear or earpad earspeakers) and circumaural earspeakers (over-ear or earcup earspeakers). The headband keeps the headphone in place by sitting on top of the user's head whilst the earspeakers are positioned on the user's ears. Commonly, the headband resiliently biases the earpeakers onto the user's ears or the sides of the user's head, thereby clamping the earspeakers to the user's head. More particularly, the headband is usually made of a resilient material, and when not mounted on a user's head, the distance between the earspeakers is narrower than the distance between a typical user's ears. Thus, when the earspeakers are pulled apart to fit onto the user's ears by flexing the resilient material of the headband, this creates a resilient bias in the headband which clamps the earspeakers to the user's ears or the sides of the user's head. To allow a better fit to a range of head sizes and shapes, prior headbands can be adjusted to vary the length of the headband. The position and angle of the earspeakers can also be adjusted by way of joints on the headband.

However, headphones with these prior headbands are still unstable in certain usage situations. For example, when a user is wearing a headphone whilst jogging, exercising, playing sports, dancing, DJing, or engaging in other vigorous physical activities, prior headbands often do not provide sufficient stability to maintain the headphone in a fixed position relative to the user's head. The movement of the user's body or head during such activities can cause movement of the earspeakers relative to the ears or even dislodge the headphone from the user's head. This can also occur when the user's head is moved into a non-upright position, for example, when reading or bending over.

To address these problems, some prior headbands have been designed to have an increased resilient bias when they are fitted over a user's head so that earspeakers are clamped more strongly to a user's head. However, this decreases the comfort of wearing such headphones, especially over longer periods of time.

Other prior headbands have been designed to be wider to increase the surface area of the headband that will come in contact with a user's head, thereby improving stability. However, the improvements are minimal and such headbands increase the bulk and weight of headphones which decreases comfort and usability.

One prior headband is a split headband with a first portion and a second portion of the headband rotatably mounted together via simple sliding pivot joints. The sliding pivot joints have corresponding members that slidingly rotate relative to each other such that the first and second portions can be manually and continuously rotated relative to each other. In this way, a user can set the desired relative positions of the portions. However, when this headband is mounted on the user's head, movement of the user's head or bumping of the headphone can cause the first and second portions to rotate relative to each other out of the relative positions previously set by the user.

Another prior headband is similarly split into a first portion and a second portion. However, the first and second portions are also resiliently biased together. A user sets the relative positions of the portions by rotating the portions away from each other, and the headband is then placed on the user's head. Friction between the user's head and the headband portions keeps the portions apart at the relative positions set by the user. However, once the headband is lifted away from the user's head, and there is no longer any friction between the user's head and the portions, the resilient bias snaps the portions back together. This prior headband has similar problems to the one described above in that, when this headband is mounted on the user's head, movement of the user's head or bumping of the headphone can cause the first and second portions to rotate towards each other out of the relative positions previously set by the user. The snapping of the portions together caused by the resilient bias also tends to catch the user's hair, causing discomfort and annoyance.

It is an object of the present invention to overcome or ameliorate at least one of the disadvantages of the prior art, or to provide a useful alternative.

### SUMMARY OF THE INVENTION

The present invention provides, in a first aspect, a headband for a headphone, the headband comprising:

a primary band for placement over a user's head to support the headphone on the user's head; and

a secondary band mounted to the primary band, the secondary band rotatable relative to the primary band into one or more indexed positions to further support the headphone on the user's head.

In one embodiment, the secondary band is resiliently biased from each indexed position, with the exception of a last indexed position, to a next indexed position.

In another embodiment, the secondary band is resiliently biased from a first indexed position to a second indexed position. In one embodiment, the secondary band is aligned with the primary band in the first indexed position, and the secondary band is rotated 35° rearwards from the primary band in the second indexed position.

In one embodiment, the secondary band is releasably locked at one or more of the indexed positions from which the secondary band is biased such that unlocking of the secondary headband allows the resilient bias to automatically move the secondary band to the next indexed position. In one embodiment, the secondary band is releasably locked by a spring lock mechanism. In one embodiment, the headband comprises a release button for unlocking the secondary band.

In one embodiment, the secondary band is resiliently biased by a torsional spring.

In one embodiment, the primary band has a complementary recess for stowing the secondary band such that the secondary band sits flush with the primary band when stowed.

In one embodiment, one or both of the primary and secondary bands have an adjustable length.

In one embodiment, the headband comprises one or more lights, one or more reflective portions, or a combination of both to enhance visibility of the user wearing the headband.

In one embodiment, one or both of the primary and secondary bands is made from a soft material covering a rigid spine.

In a second aspect, the present invention provides a headphone comprising a headband as described above, and an earspeaker mounted at one end of the primary band, or two earspeakers each mounted at a respective end of the primary band.

In one embodiment, the headphone comprises one or more lights, one or more reflective portions, or a combination of both to enhance visibility of the user wearing the headphone.

In one embodiment, one or both earspeakers comprise a safe sound mode in which one or more characteristics of an audio track being played back through one or both earspeakers are modified to allow an increased level of ambient sound to be heard by the user, the headphone having a safe sound switch operable by the user to actuate the safe sound mode. In one embodiment, the one or more characteristics is output sound level, and in the safe sound mode, the output sound level is reduced.

Throughout this specification, including the claims, the words “comprise”, “comprising”, and other like terms are to be construed in an inclusive sense, that is, in the sense of “including, but not limited to”, and not in an exclusive or exhaustive sense, unless explicitly stated otherwise or the context clearly requires otherwise.

### BRIEF DESCRIPTION OF THE FIGURES

Preferred embodiments in accordance with the best mode of the present invention will now be described, by way of example only, with reference to the accompanying figures, in which the same reference numerals refer to like parts throughout the figures unless otherwise specified, and in which:

FIG. 1 is a perspective view of a headphone in accordance with an embodiment of the present invention;

FIG. 2 is a front view of the headphone of FIG. 1;

FIG. 3 is a back view of the headphone of FIG. 1;

FIG. 4 is a top view of the headphone of FIG. 1;

FIG. 5 is an underside view of the headphone of FIG. 1;

FIG. 6 is a left side view of the headphone of FIG. 1;

FIG. 7 is a right side view of the headphone of FIG. 1;

FIG. 8 is a perspective view of the headphone of FIG. 1 with the secondary band rotated into an indexed position rearward of the primary band;

FIG. 9 is a left side view of the headphone of FIG. 8;

FIG. 10 is a perspective view of the headphone of FIG. 1 with the secondary band rotated into an indexed position rearward of the primary band, and with the secondary band also extended;

FIG. 11 is a left side view of the headphone of FIG. 10; and

FIG. 12 is an exploded view of a torsional spring lock mechanism of a headband in accordance with an embodiment of the present invention.

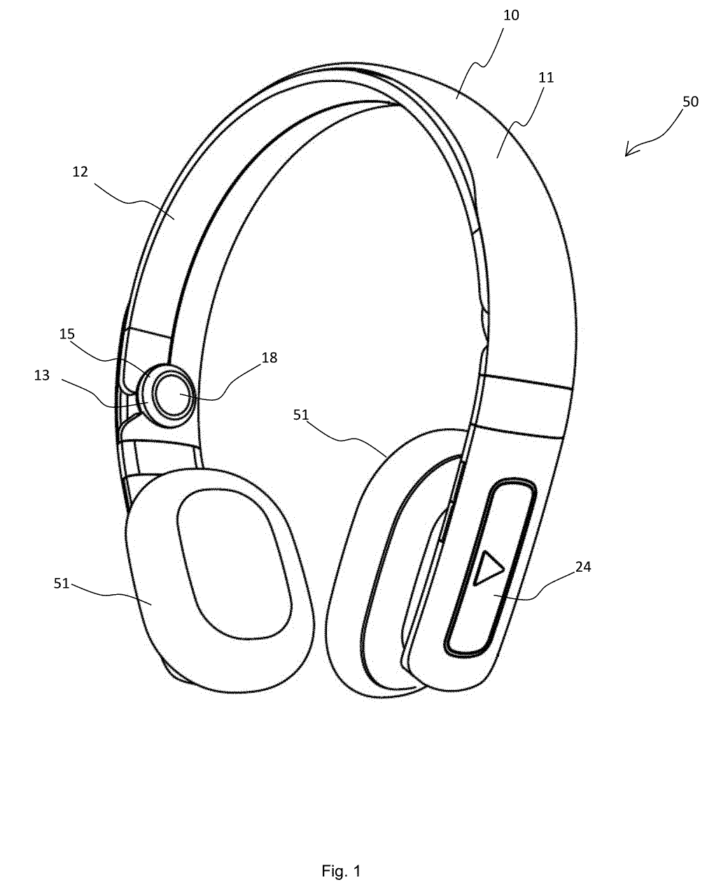

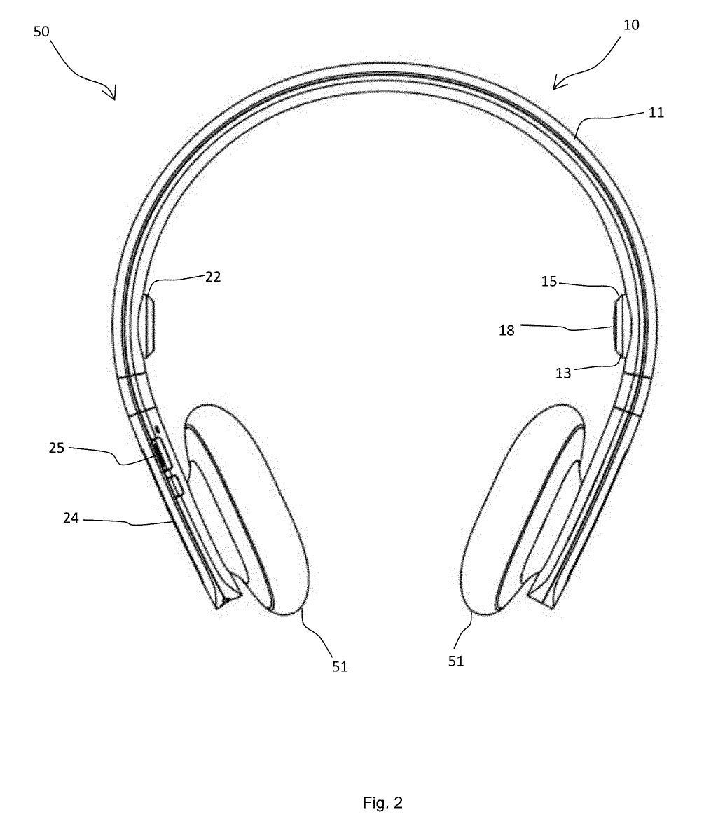

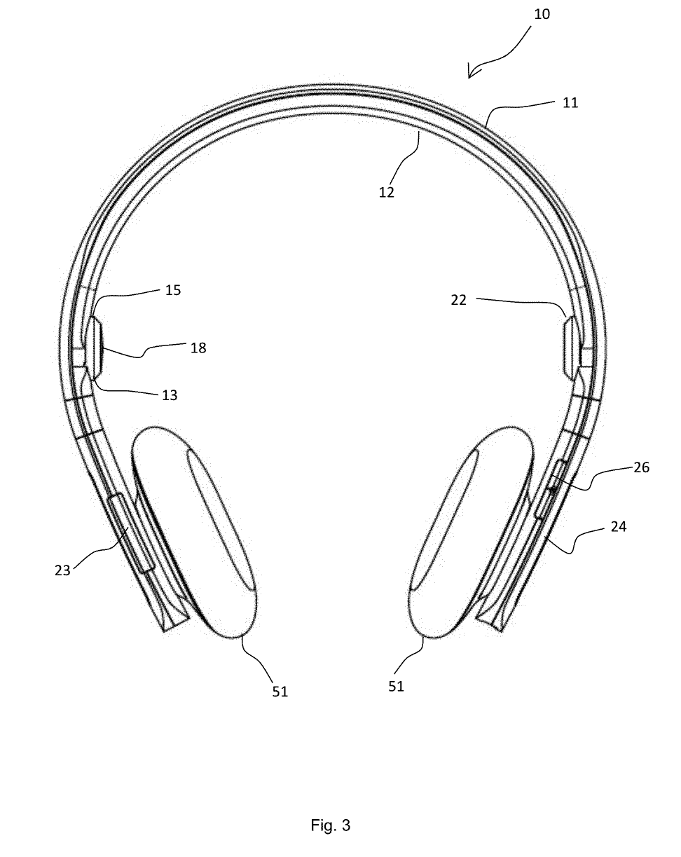

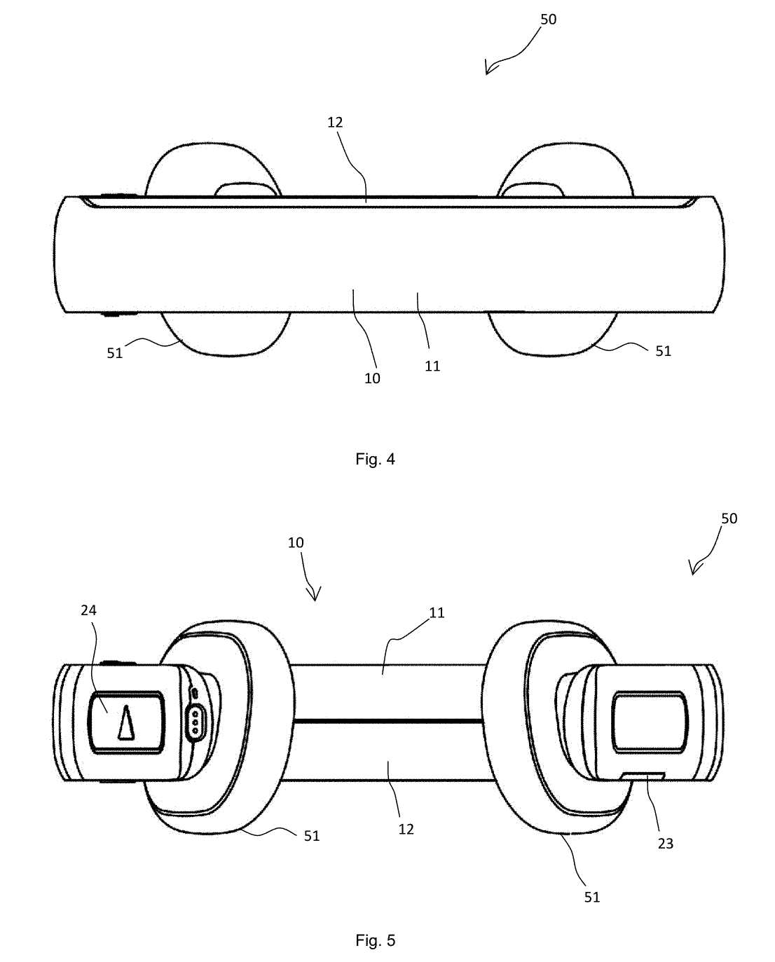

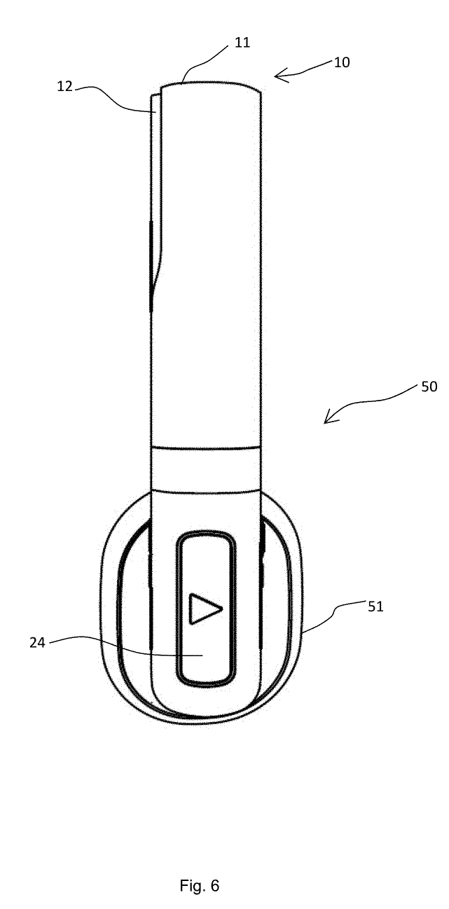

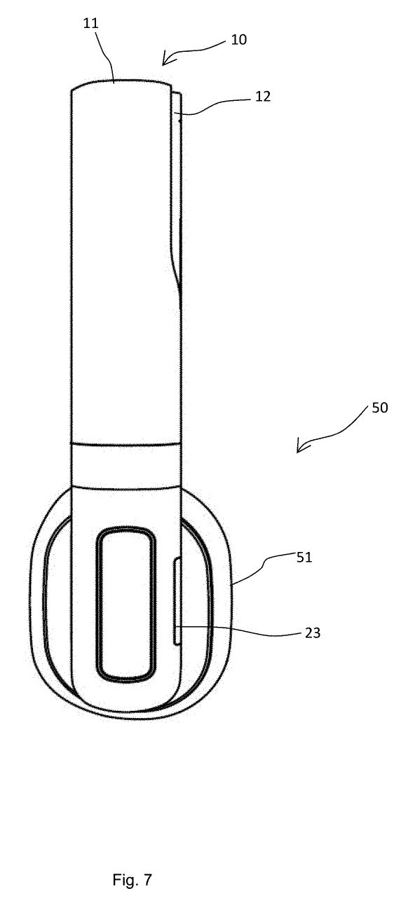

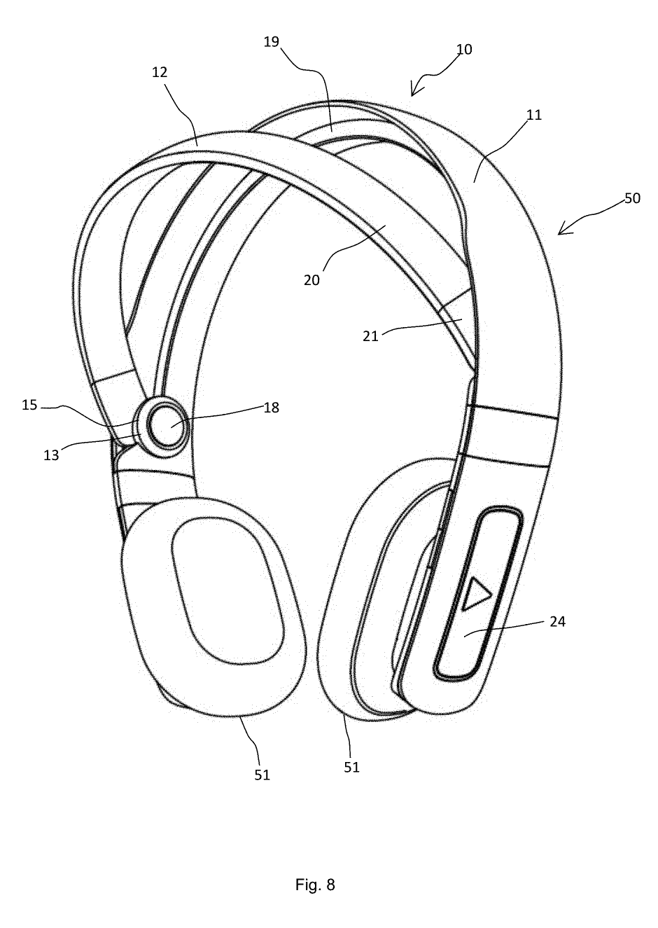

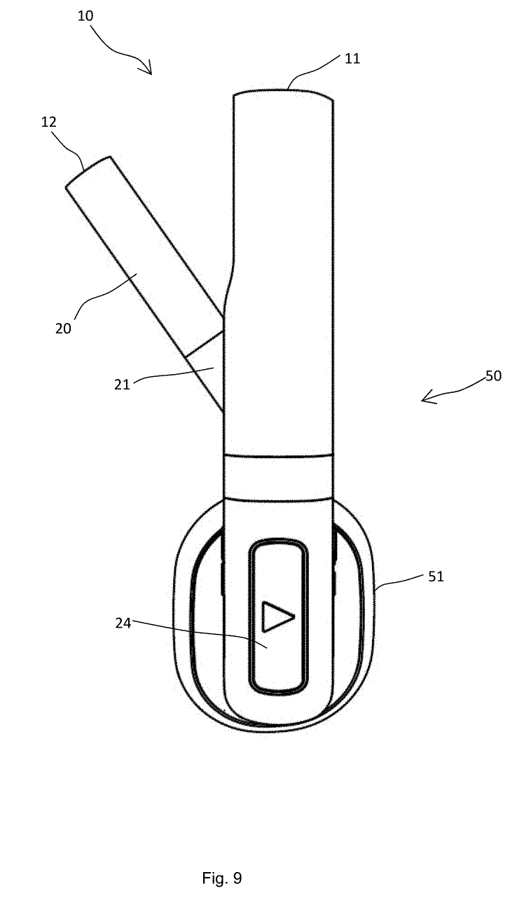

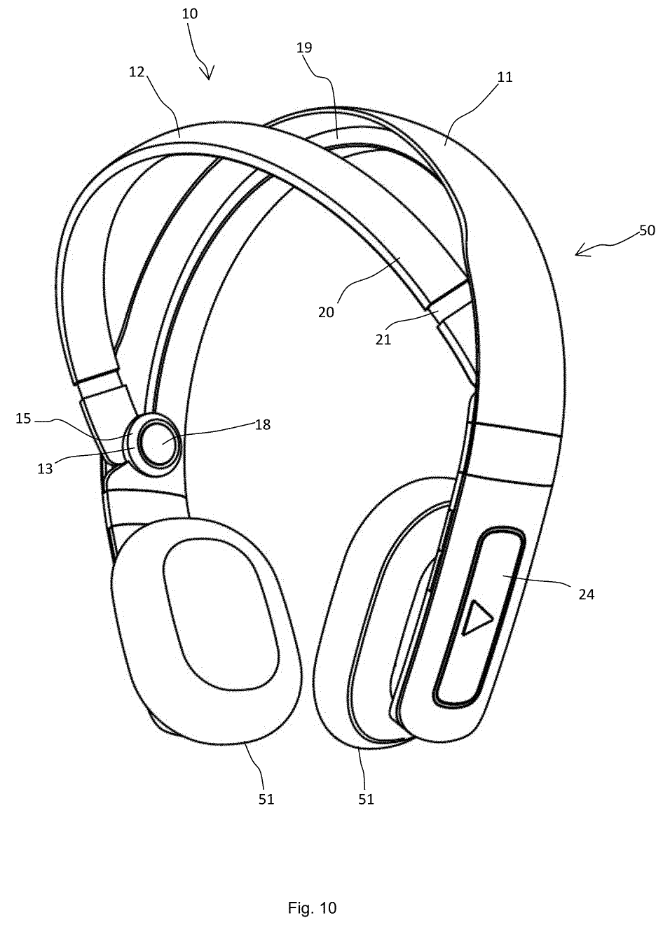

### DETAILED DESCRIPTION OF PREFERRED EMBODIMENTS OF THE INVENTION

Referring to the figures, there is provided a headband 10 for a headphone 50. The headband 10 comprises a primary band 11 for placement over a user's head to support the headphone 50 on the user's head. A secondary band 12 is mounted to the primary band 11, and the secondary band is rotatable relative to the primary band into one or more indexed positions to further support the headphone 50 on the user's head.

It is to be understood that an “indexed” position is a position defined by a discrete engagement between the primary and secondary bands. For example, the indexed positions can be defined by discrete stops, detents, or clicks positioned at intervals along the path of rotation as the secondary band is rotated relative to the primary band. Structurally, these discrete stops, detents, or clicks can be formed from, for example, abutment portions, and projections fitting into complementary recesses. In the latter example, the projections can be resiliently biased such that the projections move automatically into place in the complementary recesses once the projections move over the complementary recesses. In any event, the discrete engagement defining each indexed position means that whilst the primary and secondary bands rotate relative to each other under a certain amount of force, once an indexed position is reached, an additional amount of force or an unlocking action is required to further rotate the primary and secondary bands relative to each other.

The secondary band 12 can be resiliently biased from each indexed position, with the exception of a last indexed position, to a next indexed position. In the embodiments shown in the figures, the secondary band 12 is resiliently biased from a first indexed position to a second indexed position. The secondary band 12 is aligned with the primary band 11 in the first indexed position, and the secondary band is rotated 35° rearwards from the primary band in the second indexed position. It has been found that having the secondary band at 35° rearwards from the primary band provides an unexpected level of stability to the headphone when a user is engaged in activities involving movement, including sports, physical exercise, and dancing.

The secondary band 12 is releasably locked at one or more of the indexed positions from which the secondary band is biased such that unlocking of the secondary headband allows the resilient bias to automatically move the secondary band to the next indexed position. As best shown in FIG. 12, the secondary band is releasably locked by a spring lock mechanism 13. In the example shown, the secondary band is resiliently biased by a torsional spring 14. As such, the spring lock mechanism 13 is a torsional spring lock mechanism. This allows the spring lock mechanism 13 to be relatively compact. In the embodiment shown, the torsional spring lock mechanism 13 is integrated into a pivot joint 15 between the primary and secondary bands 11 and 12. More particularly, the pivot joint 15 is formed by a secondary pivot member 16 at an end of the secondary band 12, and the secondary pivot member 16 is connected to a complementary primary pivot member 17 at a location adjacent a corresponding end of the primary band 11.

The headband 10 also comprises a release button 18 for unlocking the secondary band. The release button 18 is located on an easily accessible outside surface of the pivot joint 15. This provides convenient actuation by the user as it is easily accessible by feel whilst the headband is still in place on the user's head, without the need for the user to see the release button or to take off the headband 10 to locate the release button.

The primary band 11 has a complementary recess 19 for stowing the secondary band 12 such that the secondary band sits flush with the primary band when stowed. This results in a compact configuration and clean lines when the secondary band 12 is stowed. In particular, it allows the headband 10 to resemble prior single-band headbands when the secondary band 12 is stowed. In the example shown in the figures, the complementary recess 19 is a cutout in the underside of the primary band 11 that closely approximates the shape of the secondary band 12.

One or both of the primary and secondary bands 11 and 12 have an adjustable length. In the embodiments shown in the figures, the secondary band 12 has a sleeved portion 20 that is sleeved over a base portion 21. The base portion 21 comprises two segments, one projecting from the pivot joint 15 and the other projecting from another pivot joint 22 connecting another end of the secondary band 12 to the primary band 11 at a location adjacent a corresponding end of the primary band 11. The sleeved portion 20 is slidable along the base portion 21 thereby lengthening the secondary band 12. In embodiments where the secondary band 12 is stowed underneath the primary band 11 and there is a reduction in length in the secondary band to allow such stowage, this lengthening of the secondary band 12 can compensate for this reduced length when the secondary band is not stowed and is instead deployed.

When the secondary band 12 is stowed under the primary band 11, a catch holds and thereby locks the secondary band in place. This defines the discrete engagement that characterizes the first indexed position. In this first indexed position, the torsional spring 14 has been wound tighter than a normally relaxed configuration of the torsional spring. The torsional spring 14 is therefore held in this tighter configuration by the catch and resiliently biases the secondary band 12 away from the primary band 11.

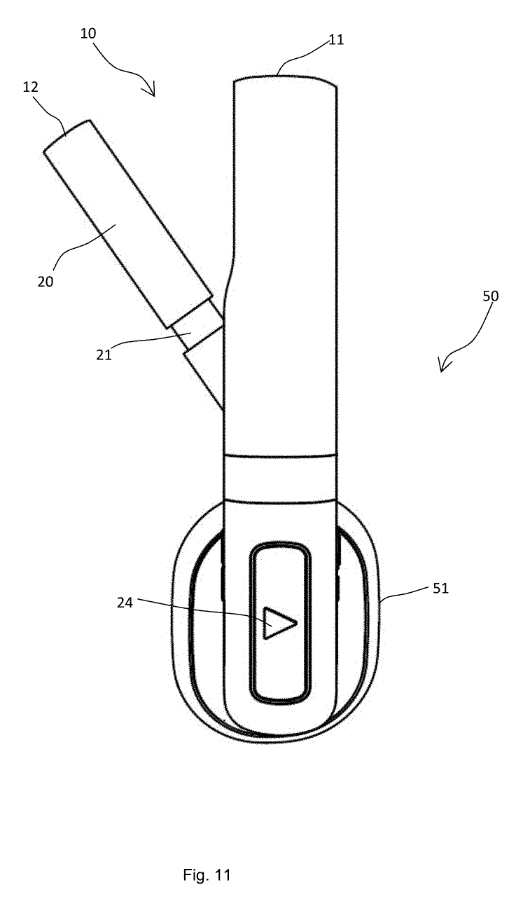

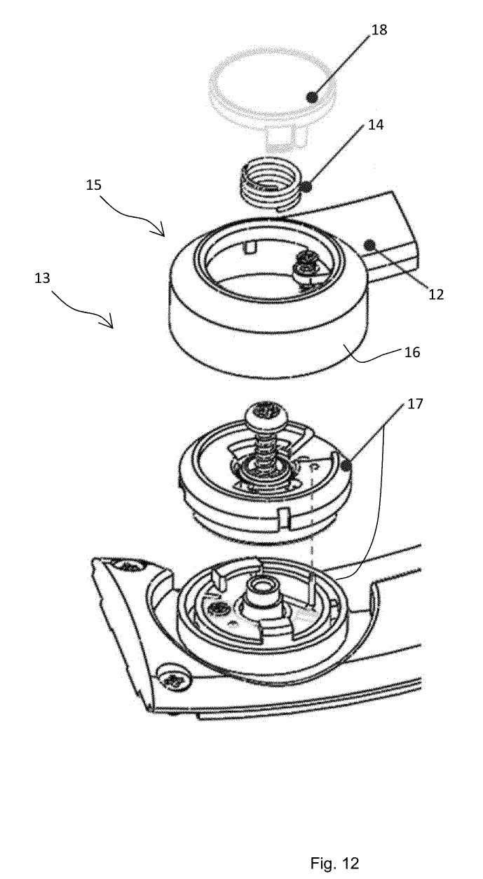

Pushing of the release button 18 releases the secondary band 12 from the catch, and the resilient bias of the torsional spring 14 automatically rotates the secondary band 12 away from the primary band 11. The primary pivot member 17 includes an abutment surface and the secondary pivot member 16 includes a stop surface. Rotation of the secondary band 12 away from the primary band 11 moves the stop surface towards the abutment surface. When the stop surface reaches and abuts against the abutment surface, rotation of the secondary band 12 stops. This defines the discrete engagement that characterizes the second indexed position. The stop surface and the abutment surface are positioned and configured so that the second indexed position is where the secondary band 12 is rotated 35° rearwards from the primary band 11. Once the secondary band 12 has been released towards the second indexed position, the sleeved portion 20 can be pulled upwards along the base portion 21 to lengthen the secondary band, as best shown in FIGS. 10 and 11.

To stow the secondary band 12 back under the primary band 11, the user rotates the secondary band 12 back towards the first indexed position. This winds the torsional spring 14 against the resilient bias of the torsional spring, thereby building up resilient bias in the spring which urges the secondary band 12 away from the primary band 11. The secondary band 12 is rotated, and therefore the torsional spring continues to be wound, until the secondary band reaches the first indexed position, that is, the stowage position under the primary band 11. The catch then holds the secondary band 12 in place in the first indexed position under the primary band 11 until the next time a user actuates the release button 18.

The primary and secondary bands 11 and 12 are arcuate to approximate the shape of the user's head. One or both of the primary and secondary bands is made from a soft material covering a rigid spine.

The headband 10 comprises one or more lights 23, one or more reflective portions, or a combination of both to enhance visibility of the user wearing the headband. The lights 23 can be operated by circuitry comprising a light sensor so that the lights automatically switch on or off depending on threshold light levels sensed by the light sensor. Alternatively, or in combination, the circuitry can increase or decrease the brightness of the lights depending on the light levels sensed by the light sensor. The lights can also be configured to flash or change colour depending on user selection, or automatically depending on certain parameters or measurements by one or more sensors of one or more type.

The headphone 50 comprises a headband 10 of one of the embodiments described above. In the embodiment shown in the figures, the headphone 50 comprises two earspeakers 51 each mounted at a respective end of the primary band 11. In other embodiments, the headphone comprises only one earspeaker 51 mounted at one end of the primary band 11. The headphone 50 can also include a microphone which can be mounted on a distal end of an adjustable boom with a proximal end connected to one end of the primary band 11.

Instead of the being on the headband 10, one or more lights, one or more reflective portions, or a combination of both can be included on other portions of the headphone 50 to enhance visibility of the user wearing the headphone.

One or both earspeakers 51 comprise a safe sound mode in which one or more characteristics of an audio track being played back through one or both earspeakers are modified to allow an increased level of ambient sound to be heard by the user. The headphone 50 has a safe sound switch operable by the user to actuate the safe sound mode. In one embodiment, the one or more characteristics is output sound level, and in the safe sound mode, the output sound level is reduced. This enhances the safety of the user. For example, the user can place the earspeakers into the safe sound mode, which can be characterized by a reduction in output sound level, when the user is about to cross a road. In this way, an increased level of ambient sound is heard by the user which will allow the user to detect traffic noises more effectively to determine oncoming vehicles.

The headband 10 or other portions of the headphone 50 can include other buttons and connection ports to facilitate other functionalities of the headphone. For example, the headband 10 can include a play button 24 to turn playback on or off. In the embodiments shown in the figures, the play button 24 is a large easily accessible button on a lower outside surface of the headband adjacent one of the earspeakers 51. The headband 10 can also include a charging port 25 for receiving a plug for charging, and a memory card port 26 for receiving a memory card on which media to be played by the headphone 50 is stored.

It is appreciated that the aforesaid embodiments are only exemplary embodiments adopted to describe the principles of the present invention, and the present invention is not merely limited thereto. Various variants and modifications can be made by those of ordinary skill in the art without departing from the spirit and essence of the present invention, and these variants and modifications are also covered within the scope of the present invention. Accordingly, although the invention has been described with reference to specific examples, it is appreciated by those skilled in the art that the invention can be embodied in many other forms. It is also appreciated by those skilled in the art that the features of the various examples described can be combined in other combinations.

What is claimed is:

1. A headband for a headphone, the headband comprising:
a primary band for placement over a user's head to support the headphone on the user's head; and
a secondary band mounted to the primary band, the secondary band rotatable relative to the primary band into one or more indexed positions to further support the headphone on the user's head.

2. The headband of claim 1 wherein the secondary band is resiliently biased from each indexed position, with the exception of the last indexed position, to a next indexed position.

3. The headband of claim 1 wherein the secondary band is resiliently biased from the first indexed position to a second indexed position.

4. The headband of claim 3 wherein the secondary band is aligned with the primary band in the first indexed position, and the secondary band is rotated 35° rearwards from the primary band in the second indexed position.

5. The headband of claim 2 wherein the secondary band is releasably locked at one or more of the indexed positions from which the secondary band is biased such that unlocking the secondary headband allows the resilient bias to automatically move the secondary band to the next indexed position.

6. The headband of claim 5 wherein the secondary band is releasably locked by a spring mechanism.

7. The headband of claim 5 comprising a release button for unlocking the secondary band.

8. The headband of claim 2 wherein the secondary band is resiliently biased by a torsional spring.

9. The headband of claim 1 wherein the primary band has a complementary recess for stowing the secondary band such that the secondary band sits flush with the primary band when stowed.

10. The headband of claim 1 wherein one of both of the primary and secondary bands have an adjustable length.

11. The headband of claim 1 comprising one or more lights, one or more reflective portions, or a combination of both to enhance visibility of the user wearing the headband.

12. The headband of claim 1 wherein one or both of the primary and secondary bands is made from a soft material covering a rigid spine.

13. A headphone comprising the headband of claim 1, further comprising an earspeaker mounted at one end of the primary band, or two earspeakers each mounted at a respective end of the primary band.

14. The headphone according to claim 13 comprising one or more lights, one or more reflective portions, or a combination of both to enhance visibility of the user wearing the headphone.

15. The headphone of claim 13 wherein one or both earspeakers comprise a safe sound mode in which one or more characteristics of an audio track being played back through one or both earspeakers are modified to allow an increased level of ambient sound to be heard by the user, the headphone having a safe sound switch operable by the user to actuate the safe sound mode.

16. The headphone of claim 15 wherein the one or more characteristics is output sound level, and in the safe sound mode, the output sound level is reduced.

17. The headband of claim 3 wherein the secondary band is releasably locked at one or more of the indexed positions from which the secondary band is biased such that unlocking the secondary headband allows the resilient bias to automatically move the secondary band to the next indexed position.

18. The headband of claim 3 wherein the secondary band is resiliently biased by a torsional spring.
